(19) United States
(12) Patent Application Publication
(10) Pub. No.: US 2018/0087551 A1
(43) Pub. Date: Mar. 29, 2018

(54) Connector

(71) Applicant: Yue Hong CHEN, GuangDong (CN)

(72) Inventor: Yue Hong CHEN, GuangDong (CN)

(21) Appl. No.: 15/356,669

(22) Filed: Nov. 21, 2016

(30) Foreign Application Priority Data
Sep. 27, 2016 (CN) 201621090094.7

(51) Int. Cl. F16B 12/20; F16B 12/22; F16B 5/06

(52) U.S. Cl. CPC F16B 12/2009; F16B 5/0614; F16B 12/22

(57) ABSTRACT

The present invention discloses a connector, comprising part 1 and 2 that can be separated; part 1 comprises base and rotating rod , rotating rod horizontally penetrates the base and can rotate; rotating rod is provided with a pick on it and a fixture block at one end which is located at exterior of base; part 2 is provided with a cavity with T-shape cross section in it and the lower end of cavity's vertical part is connected with outside; the width of cavity's vertical part is slightly greater than the length of fixture block, and the length of cavity's vertical part is slightly less than the length of fixture block but slightly greater than the width of fixture block. Through two separated parts respectively preset in the furniture, consumers can connect two parts of furniture with aided tools and simple operation, thus being more flexible and convenient.

### BACKGROUND OF THE INVENTION

The present invention relates to a connector, particularly to the connection and combination of two parts of an article, and is applied in the furniture field.

At present, along with the development of e-commerce and logistics transportation, online shopping is also vigorously developed in the furniture industry. People can select style online and manufacturers or dealers can directly send goods to consumers. However, in traditional marketing channels, furniture is generally assembled as a whole and sold with large volume and inconvenient transportation. To solve such problem, furniture is now generally split into several parts to reduce the transportation volume. Then, connection tools and installation methods are provided to consumers for self-help installation. Yet, the current connection tools are mainly screw, nut and other tools, as well as such aided tools as electric or manual screwdriver, which is rater inconvenient.

### BRIEF SUMMARY OF THE INVENTION

Specific to the shortage of the existing technology, the present invention aims at providing a connector in two separated parts which can be respectively preset in two parts of the furniture to be combined together. Consumers can connect two parts of the furniture via the connection of two parts of the connector through clamping without aided tools, which is flexible and convenient.

To achieve the aforesaid objective, the following technical proposal is adopted in the present invention:

A connector, is characterized in that it comprises a part 1 and a part 2 that can be separated; the said part 1 comprises a base and a rotating rod and the said rotating rod horizontally penetrates the said base and can rotate; the said rotating rod is provided with a pick on it and a fixture block at one end, and the said fixture block is located at exterior of the said base; the said part 2 is provided with a cavity with T-shape cross section in it and the lower end of the vertical part of the said cavity is connected with the outside; the width of the vertical part of the said cavity is slightly greater than the length of the said fixture block, and the length of the vertical part of the said cavity is slightly less than the length of the said fixture block but slightly greater than the width of the said fixture block.

Usage of the said connector: manufacturers will respectively put part 1 and part 2 on two parts of the furniture to be combined in advance and align the fixture block of the part 1 with the lower end of the vertical part of the part 2. During combination, it is required to first stir the pick of the said part 1 to drive the said rotating rod to rotate, so as to drive the fixture block at one end of the said rotating rod to rotate. Rotate the pick until the length direction of the said fixture block is parallel to the width direction of the vertical part of the said cavity. Since the width of the vertical part of the said cavity is slightly greater than the length of the said fixture block and the length of the vertical part of the said cavity is slightly greater than the width of the said fixture block, the fixture block of the part 1 will stretch into the lower end of the vertical part of the cavity of the part 2 until the transverse part of the cavity when combining two parts of the furniture together. Then, stir back the pick so that the length direction of the said fixture block is parallel to the length direction of the vertical part of the cavity. Since the length of the vertical part of the said cavity is less than the length of the said fixture block, the fixture block is stuck in the transverse part of the said cavity, so as to realize the connection of the part 1 and the part 2 and finally achieve the connection of two parts of the furniture.

It is preferred that the said base is respectively provided with a through-hole at each side with center on the same line; the minimum inner diameter of the two through-holes is greater than the maximum inner diameter of the said rotating rod; and the said rotating rod horizontally penetrates the said base via the two said through-holes.

It is further preferred that the said base falls into two halves and the two through-holes also correspondingly fall into two halves; bottom of two halves of the base can rotate and connect with concave on one half and matched bulge on the other half on the bonding surface, so that the said bulge can be embedded in the said concave when two halves of the base are bond together. The said base falls into two halves and the two through-holes also correspondingly fall into two halves, so that the rotating rod horizontally penetrating the base can be taken out of the base after separation of the base into two halves, which is very convenient no matter for production assembly or later damage replacement.

Beneficial effect of the present invention is: through the design of two separated parts, two parts can be respectively preset in two parts of the furniture to be combined together. Consumers can connect two parts of the furniture via the connection of two parts of the connector with aided tools and simple operation, thus being more flexible and convenient.

### BRIEF DESCRIPTION OF THE DRAWINGS

FIG. 1 shows the schematic diagram of the part 1 in the present invention;

FIG. 2 shows the schematic diagram of the rotating rod, pick and fixture block in FIG. 1;

FIG. 3 shows the schematic diagram for combination of the base in FIG. 1;

FIG. 4 shows the schematic diagram for opening of the base in FIG. 1;

FIG. 5 shows the schematic front cross section diagram for the part 2 in the present invention;

FIG. 6 shows the three-dimensional schematic diagram for the part 2 in FIG. 4;

FIG. 7 shows the schematic cross section diagram in FIG. 6;

FIG. 8 shows the schematic diagram for connection of the fixture block of the part 1 and the part 2 in the present invention;

FIG. 9 shows the schematic diagram for rotation of the fixture block to be stuck in the part 2 in FIG. 8;

FIG. 10 shows the external schematic diagram after the connection of the part 1 and the part 2 in the present invention;

FIG. 11 shows the application schematic diagram in the present invention;

FIG. 12 shows the enlarged schematic diagram for part A in FIG. 1;

FIG. 13 shows the schematic diagram after the combination of two parts of furniture in FIG. 11;

FIG. 14 shows the enlarged schematic diagram for part B in FIG. 13.

### DETAILED DESCRIPTION OF THE INVENTION

The present invention will be further described based on the drawings. It is required to note that this embodiment gives detailed mode of execution and specific operation process based on this technical proposal. However, the protection scope of the present invention is not limited to this embodiment.

As shown in FIG. 10, a connector comprises a part 1 and a part 2 that can be separated.

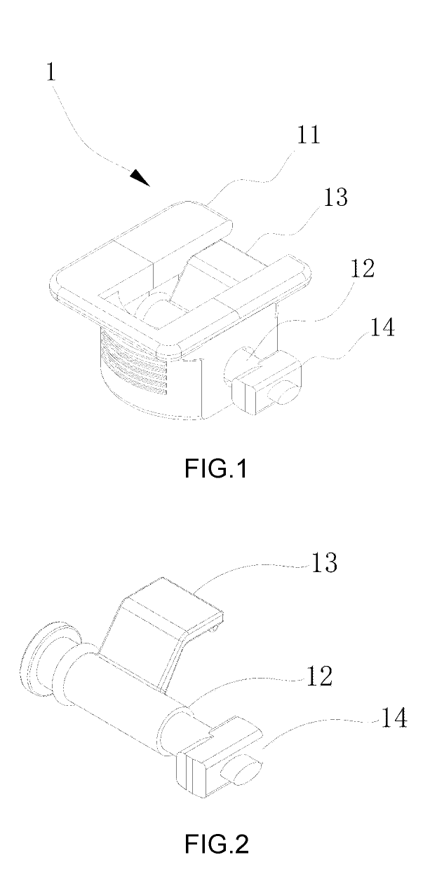

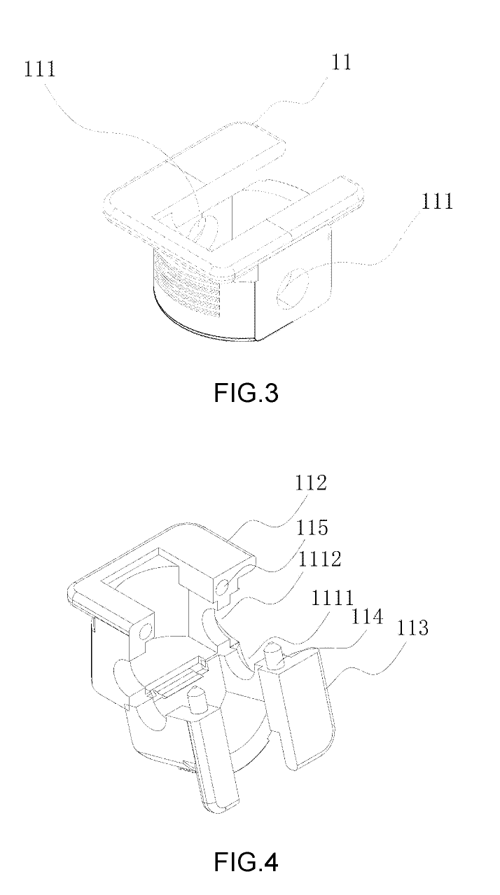

As shown in FIG. 1-4, the said part 1 comprises a base 11 and a rotating rod 12 and the said rotating rod 12 horizontally penetrates the said base 11 and can rotate; the said rotating rod 12 is provided with a pick 13 on it and a fixture block 14 at one end, and the said fixture block 14 is located at exterior of the said base 11.

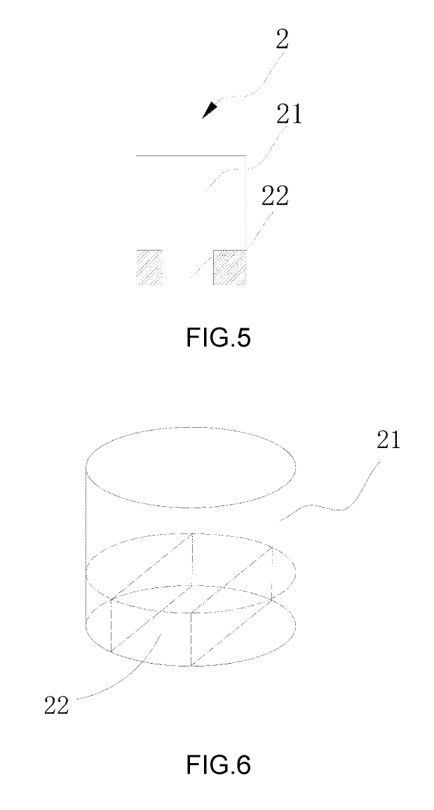

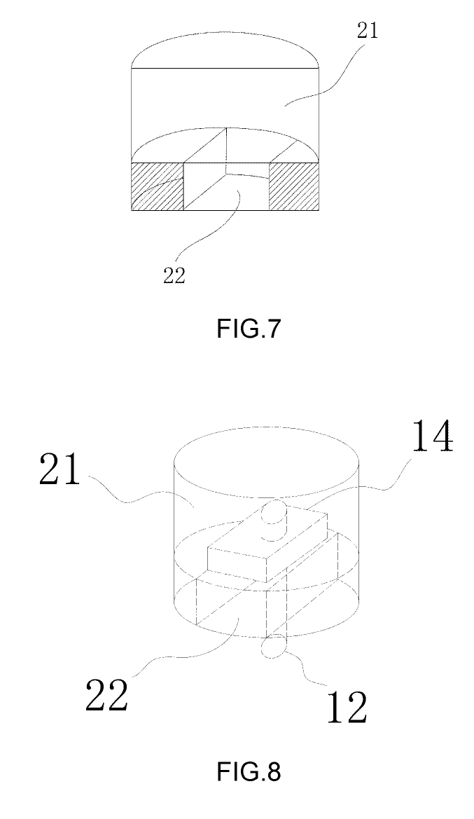

As shown in FIG. 5-7, the said part 2 is provided with a cavity with T-shape cross section in it which falls into a transverse part 21 and a vertical part 22 and the lower end of the vertical part 22 of the said cavity is connected with the outside; the width of the vertical part 22 of the said cavity is slightly greater than the length of the said fixture block 14, and the length of the vertical part 22 of the said cavity is slightly less than the length of the said fixture block 14 but slightly greater than the width of the said fixture block 14.

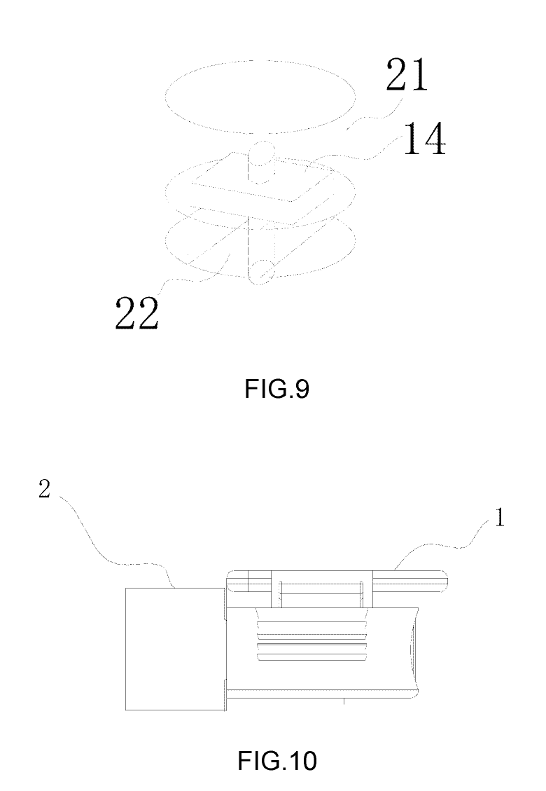

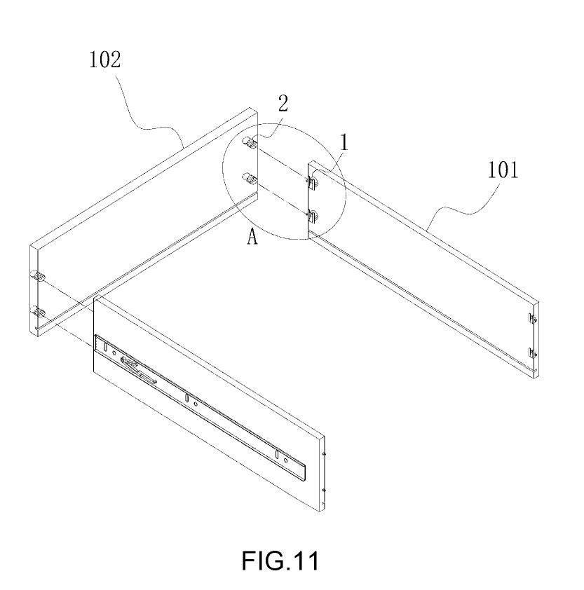

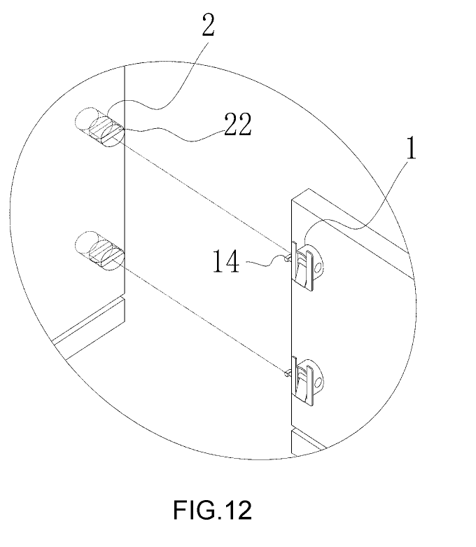

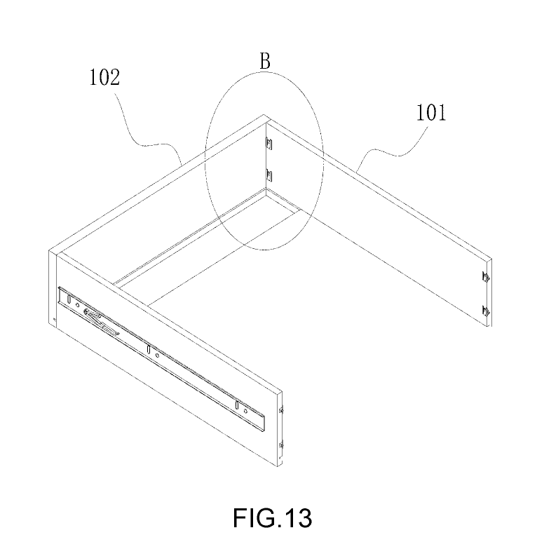

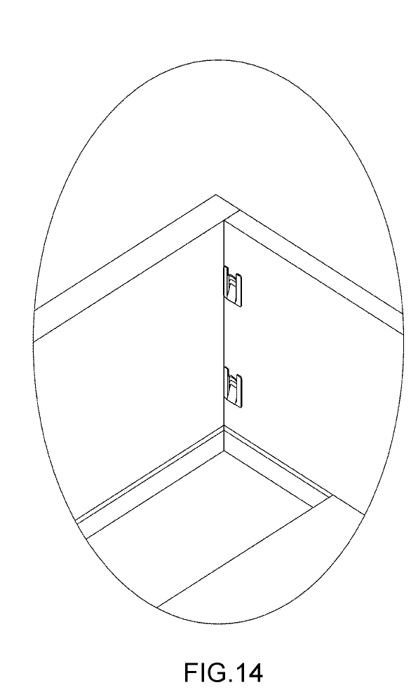

Usage of the said connector: as shown in FIG. 11-14, manufacturers will respectively put part 1 and part 2 on two parts 101 and 102 of the furniture to be combined in advance. In this embodiment, the said part 2 is embedded in the part 102 of the furniture. Align the fixture block 14 of the part 1 with the lower end of the vertical part 22 of the part 2. During combination, it is required to first stir the pick 13 of the said part 1 to drive the said rotating rod 12 to rotate, so as to drive the fixture block 14 at one end of the said rotating rod 12 to rotate. Rotate the pick 13 until the length direction of the said fixture block 14 is parallel to the width direction of the vertical part 22 of the said cavity. Since the width of the vertical part 22 of the said cavity is slightly greater than the length of the said fixture block 14 and the length of the vertical part 22 of the said cavity is slightly greater than the width of the said fixture block 14, the fixture block 14 of the part 1 will stretch into the lower end of the vertical part 22 of the cavity of the part 2 until the transverse part 21 of the cavity (as shown in FIG. 8) when combining two parts of the furniture together. Then, stir back the pick so that the length direction of the said fixture block 14 is parallel to the length direction of the vertical part 22 of the cavity. Since the length of the vertical part 22 of the said cavity is less than the length of the said fixture block 14, the fixture block 14 is stuck in the transverse part 21 of the said cavity (as shown in FIG. 9), so as to realize the connection of the part 1 and the part 2 (as shown in FIG. 10) and finally achieve the connection of two parts of the furniture. To separate two parts of the furniture, it is required to follow the reverse operation. To clearly display the relationship between the fixture block and the cavity of the part 2, the base and the pick are omitted in the part 1. FIG. 13 shows the schematic diagram after the combination of the part 101 and 102 of the furniture.

It is preferred that the said base is respectively provided with a through-hole 111 at each side with center on the same line; the minimum inner diameter of the two through-holes 111 is greater than the maximum inner diameter of the said rotating rod 12; and the said rotating rod 12 horizontally penetrates the said base 11 via the two said through-holes 111.

It is further preferred that the said base 11 falls into two halves 112 and 113 and the two through-holes 111 also correspondingly fall into two halves 1111 and 1112; bottom of two halves 112 and 113 of the base 11 can rotate and connect (realized via such conventional method as hinge) with concave 115 on one half 112 and matched bulge 114 on the other half 113 on the bonding surface, so that the said bulge 114 can be embedded in the said concave 115 when two halves of the base are bond together. The said base falls into two halves and the two through-holes also correspondingly fall into two halves, so that the rotating rod horizontally penetrating the base can be taken out of the base after separation of the base into two halves, which is very convenient no matter for production assembly or later damage replacement.

Those skilled in the art can make various corresponding changes and deformations based on the technical proposal and design above, and all these changes and deformations shall be included in the protection scope as claimed in the present invention.

What is claimed is:

1. A connector, is characterized in that it comprises a part 1 and a part 2 that can be separated; the said part 1 comprises a base and a rotating rod and the said rotating rod horizontally penetrates the said base and can rotate; the said rotating rod is provided with a pick on it and a fixture block at one end, and the said fixture block is located at exterior of the said base; the said part 2 is provided with a cavity with T-shape cross section in it and the lower end of the vertical part of the said cavity is connected with the outside; the width of the vertical part of the said cavity is slightly greater than the length of the said fixture block, and the length of the vertical part of the said cavity is slightly less than the length of the said fixture block but slightly greater than the width of the said fixture block.

2. The connector as claimed in claim 1, is characterized in that the said base is respectively provided with a through-hole at each side with center on the same line; the minimum inner diameter of the two through-holes is greater than the maximum inner diameter of the said rotating rod; and the said rotating rod horizontally penetrates the said base via the two said through-holes.

3. The connector as claimed in claim 2, is characterized in that the said base falls into two halves and the two through-holes also correspondingly fall into two halves; bottom of two halves of the base can rotate and connect with concave on one half and matched bulge on the other half on the bonding surface, so that the said bulge can be embedded in the said concave when two halves of the base are bond together.
